(19) United States
(12) Patent Application Publication
(10) Pub. No.: US 2011/0052391 A1
(43) Pub. Date: Mar. 3, 2011

(54) INDEPENDENT CONTROL OF SHORTENING LINES IN AN AERODYNAMIC WING

(75) Inventors: Bernd Specht, Hanstedt (DE); Stefan Wortmann, Hamburg (DE); Hannes Gerdes, Hamburg (DE)

(73) Assignee: SkySails GmbH & Co. KG, Hamburg (DE)

(21) Appl. No.: 12/746,152

(22) PCT Filed: Dec. 4, 2007
(86) PCT No.: PCT/EP2007/010528

§ 371 Date: Sep. 21, 2010

(51) Int. Cl. B64C 27/00; B64C 27/615

(52) U.S. Cl. 416/1; 416/23

(57) ABSTRACT

The invention relates to an aerodynamic wind propulsion device, particularly for watercraft, comprising an aerodynamic wing being connected to a steering unit located below the aerodynamic wing and coupled to the aerodynamic wing via a plurality of lines, particularly steering lines and/or fixing lines, a tractive cable, wherein a first end of the tractive cable is connected to the steering unit and a second end of the tractive cable is connected to a base platform, the aerodynamic wing having an aerodynamic profile which generates a lifting force in the direction of the traction cable when the air stream direction is about perpendicular to the tractive cable, a plurality of reefing lines located across the aerodynamic wing for increasing and decreasing the lifting force by changing the shape and/or dimension of the aerodynamic wing. According to a first aspect of the invention, such an aerodynamic wind propulsion device is provided, characterized by a guiding arrangement for guiding the reefing lines, wherein at least two of the reefing lines are guided by the guiding arrangement such that said at least two reefing lines can be controlled and/or activated, particularly hauled in and veered out, independently from each other, in particular during starting and landing manoeuvres.

The invention relates to an aerodynamic wind propulsion device, particularly for watercraft, comprising an aerodynamic wing being connected to a steering unit located below the aerodynamic wing and coupled to the aerodynamic wing via a plurality of lines, particularly steering lines and/or fixing lines, a tractive cable, wherein a first end of the tractive cable is connected to the steering unit and a second end of the tractive cable is connected to a base platform, the aerodynamic wing having an aerodynamic profile which generates a lifting force in the direction of the traction cable when the air stream direction is about perpendicular to the tractive cable, a plurality of reefing lines located across the aerodynamic wing for increasing and decreasing the lifting force by changing the shape and/or dimension of the aerodynamic wing.

A further aspect of the invention is a method for controlling an aerodynamic wind propulsion device, particularly for watercraft, comprising the steps connecting an aerodynamic wing to a steering unit located below the aerodynamic wing and coupled to the aerodynamic wing via a plurality of lines, particularly steering lines and/or fixing lines, connecting a first end of a tractive cable to the steering unit and a second end of the tractive cable to a base platform, locating a plurality of reefing lines across the aerodynamic wing for increasing and decreasing the lifting force by changing the shape and/or dimension of the aerodynamic wing.

Today, carbon-based fuels like diesel or heavy fuel oil (HFO) are used as a key resource for propelling nautic vessels. Mostly, diesel engines are used to provide the driving force for the vessels. With increasing costs for such carbon-based resources it becomes attractive to apply alternative methods for providing the driving force for nautic vessels.

WO 2005/100147 A1 discloses a positioning device for controlling a wing element which is connected via a tractive cable to a ship to serve as main or auxiliary drive. Such propulsion systems based on wing elements flying at high altitude and pulling the ship via a tractive force require large-scale wing elements and the control of such wing elements is a challenging task. In WO 2005/100147 A1 it is proposed to veer out or haul in the tractive cable in response to the flight condition of the wing element. Whereas by such control mechanisms a certain degree of flight control can be achieved it is not sufficient to control the wing element in all flight conditions, in particular when the wind changes its strength or direction significantly or during starting and landing manoeuvres of the wing element.

To improve steerability of such wing elements in difficult wind conditions it is known from WO 2005/100148 A1 to couple a steering unit close below the wing element via a number of control lines and to connect the wing element to the nautic vessel via such steering unit by a tractive cable extending between the nautic vessel and the steering unit. By this, control of the wing element can be significantly improved but it is still a challenging task to control the wing element at low altitudes such as during starting and landing procedure.

WO 2005/100149 A1 proposes various sensors to improve control of a wing element towing a nautic vessel. Whereas these and the former techniques may significantly improve the steerability of aerodynamic wing elements during regular flight it remains still a quite challenging task to control the wing element at low altitudes, in particular when the strength and direction of the wind significantly and quickly changes. Loss of control over the wing element however might result in loss of the whole system since it is not possible to rescue the system if a large-scale wing element has come into contact with the water surface.

To improve steerability during starting and landing manoeuvres, WO 2005/100150 proposes a telescopic mast erected onto the foredeck of the nautic vessel close to the apparatus coupling the wing element to the nautic vessel and which is provided at a towing point in the bow area of the vessel. Using such mast, the wing element can be directly coupled to the top of the mast, thus facilitating starting and landing manoeuvres. To achieve engagement between the wing element and the top of the mast a lifeline is slidably coupled to the tractive cable at one end and connected to the wing element at the other end. This lifeline is accessible if the tractive cable has been hauled in so far that the wing element is in low altitude and can be handled such that it is decoupled from the tractive cable and guided in such a way as to pull the wing element towards the top of the mast. Whereas such a technique may significantly improve manoeuvrability of the wing element during starting and landing procedure if the lifeline is decoupled from the tractive cable and guided such that a pulling force in the direction of the top of the mast can be applied to the wing element, it is rather complicated to use and handle the lifeline in the course of the starting or landing manoeuvre and failure to couple or decouple the lifeline to/from the tractive cable may result in failure of the whole system and loss of the wing element.

It is a first object of the present invention to provide a device facilitating and improving control of a wing element especially during starting and/or landing manoeuvres.

It is a further object of the invention to control and change the aerodynamic properties of a wing element.

It is a further object of the invention to facilitate control of aerodynamic wings shaped as a hollow body.

According to a first aspect of the invention, an aerodynamic wind propulsion device as mentioned above is provided, characterized by a guiding arrangement for guiding the reefing lines, wherein at least two of the reefing lines are guided by the guiding arrangement such that said at least two reefing lines can be controlled and/or activated, particularly hauled in and veered out, independently from each other, in particular during starting and landing manoeuvres.

The aerodynamic wind propulsion device according to the invention provides a possibility to accurately exert control over the aerodynamic wing and its aerodynamic properties.

The reefing lines located across the aerodynamic wing function as means for changing the form and dimension of the aerodynamic wing and thus alternate the aerodynamic properties of the aerodynamic wing. The reefing lines may be connected to several different points across the aerodynamic wing such that veering out or hauling in the reefing lines will change the aerodynamic profile of the aerodynamic wing. The tensile forces applied to the reefing lines are only used to control and change the aerodynamic properties of the wing. The lifting forces generated by the aerodynamic profile are transferred to the base platform via fixing and/or tractive lines and the tractive cable, which are designed to carry the tensile loads corresponding to the generated lifting forces.

Before starting manoeuvres and after landing manoeuvres, the aerodynamic wing usually is folded and stored in a condition to minimize the required storage space. During starting and landing manoeuvres it is important to control the horizontal and vertical movements of the wing very precisely. This is a challenging task with large wings. Therefore, it is an object during starting manoeuvres to unfold the aerodynamic wing in a controlled way to avoid twisting of lines, e.g. of steering lines, fixing lines or the like, and to control the amount of lifting force generated by the aerodynamic profile of the aerodynamic wing such that a controlled rising and landing manoeuvre of the aerodynamic wing can be carried out. It is desirable to avoid situations, wherein the aerodynamic wing experiences a lifting force that is too small and thus causes the aerodynamic wing to fall back down in an uncontrolled manner, thus risking to lose the system by watering the aerodynamic wing.

On the other hand it is desirable to avoid very high lifting forces or a strong sudden change in lifting force generated by the aerodynamic profile during the starting and landing phase, because this may result in uncontrolled movements of the aerodynamic wing.

To achieve smooth and accurate control during the starting and landing phases of the aerodynamic wing the reefing lines can be veered out during starting manoeuvres and hauled in, respectively, such that the dimensions of the aerodynamic wing are successively enlarged and reduced, respectively, and its aerodynamic profile is enabled to unfold/fold.

The basic concept of the invention is to address and/or control the reefing lines separately, i.e. each reefing line or group of reefing lines can be hauled in or veered out separately, e.g. in order to ensure identical tensile forces at each of the reefing lines or to apply different tensile forces to single reefing lines at one moment in time. This means that the tensile forces applied to the reefing lines and/or the distance of hauling in or veering out are controlled separately for each of the reefing lines or groups of reefing lines, particularly by not hauling in or veering out all reefing lines at the same time and by the same amount, but rather controlling time and amount of activation of individual reefing lines to different requirements. These requirements can depend intrinsically on the location of a reefing line at the aerodynamic wing and the position, in particular the height, of the aerodynamic wing in relation to the base platform, and/or extrinsically on wind conditions, sea conditions, vessel speed or other conditions.

This separate control and/or activation of at least two reefing lines is realized by a guiding arrangement that is guiding the reefing lines. This guiding arrangement may be, for example, one or a plurality of reels, a guide rail or the like. The guiding arrangement may also be realized in that the reefing lines are guided such that at least two of the reefing lines are connected to control and/or activation means, that are adapted to control and/or activate the reefing lines independently from each other.

During landing manoeuvres the dimension of the aerodynamic wing may be successively reduced until finally the aerodynamic wing is folded and brought into its storage condition. The general requirements of controllability of the aerodynamic wing and its aerodynamic properties correspond to those occurring during starting manoeuvres.

Generally, the reefing lines are veered out during starting manoeuvres and hauled in during landing manoeuvres, the latter e.g. for preparing the wing for stowage. But temporarily, it can also be necessary to haul in reefing lines during starting manoeuvres and reciprocally veer out reefing lines during landing manoeuvres. Thus the requirements for controllability of the reefing lines during starting and landing manoeuvres are basically the same. By allowing the reefing lines to be controlled and/or activated independently from each other, the present invention provides an accurate mechanism to control the uplift force of the aerodynamic wing, particularly during starting and landing manoeuvres and thus facilitates and improves the control of the aerodynamic wing.

It is important to note that the invention efficiently improves manoeuvreability during starting and landing of the wing by allowing to decrease the dimension and/or shape and thus, the uplift and potential horizontal forces individually for separate sections of the wing.

According to a first preferred embodiment of the invention, each reefing line is guided by the guiding arrangement such that each said reefing line can be controlled and/or activated independently from at least another one of said reefing lines.

By discretely addressing every single reefing line it is possible to fully realize the above-mentioned advantages of a separate control of the reefing lines. The discrete control and/or activation of every single reefing line means that every point or section of the aerodynamic wing that is connected to a reefing line can be addressed individually. Thus a very fine tuning of the aerodynamic dimension and profile of the aerodynamic wing is possible.

According to a second preferred embodiment, each reefing line is controlled and/or activated by one reel. Providing a reel is an effective mechanism to control and/or activate the reefing lines. In the present embodiment, where every single reefing line is controlled and/or activated individually, one reel may be is associated with each reefing line, resulting in the same number of reefing lines and reels.

According to a further preferred embodiment, a coupling unit at the base platform is adapted to receive each reefing line individually. That means, that the coupling unit needs to comprise receiving means, e.g. receiving slots, for each of the reefing lines, resulting in the same number of receiving means and reefing lines.

This embodiment is especially preferred in order to provide for an improved handling of the aerodynamic wing and particularly the reefing lines in the situation when the aerodynamic wing is to be coupled to or de-coupled from the base platform during starting or landing manoeuvres. By providing separate receiving means for each reefing line it is possible to prevent the reefing lines from twisting or forming knots during starting or landing manoeuvres.

According to a further preferred embodiment at least two pairs of reefing lines are provided, each said pair comprising two reefing lines located opposite to each other on either side of a central longitudinal axis of said wing, in particular on either side of a central stick, serving as a stiffening element, located at the aerodynamic wing, wherein said two reefing lines composing one pair of reefing lines are guided by said guiding arrangement such that said two reefing lines are controlled and/or activated conjointly, and wherein at least two pairs of said pairs of reefing lines are guided by the guiding arrangement such that each pair can be controlled and/or activated independently from at least another one of said pairs.

This embodiment takes into account, that the aerodynamic wing and its aerodynamic profile usually is symmetric to a central axis, in particular the axis of a central stick or kite stick. Thus it can be desirable, to conjointly address reefing lines, that are secured to two points of the aerodynamic wing that are symmetric to this axis, by the guiding arrangement, in order to symmetrically apply forces to the aerodynamic wing and thus symmetrically change the aerodynamic profile.

Thus, while in this embodiment a first reefing line within a pair is activated synchronously to the corresponding second reefing line of said pair located opposite to the first reefing line across the kite stick, the activation of different pairs of reefing lines along the kite stick axis can be adjusted independently to meet the above-mentioned requirements. The guiding arrangement may be realized as described above.

It is understood, that all pairs of reefing lines can be controlled and/or activated individually, while the two reefing lines forming one pair can be controlled and/or activated conjointly only. That means that within one pair the same force at the same time is applied to both reefing lines forming the pair. The force applied and the time of application of one pair of reefing lines can be different from the force applied and the time of application of another pair of reefing lines, however.

According to a further preferred embodiment, at least two groups of reefing lines are provided, each said group comprising more than two reefing lines, particularly reefing lines located on one side of a central axis or said central stick, wherein said more than two reefing lines composing one group of reefing lines are guided by said guiding arrangement such that said more than two reefing lines are controlled and/or activated conjointly, and wherein at least two groups of said groups of reefing lines are guided by the guiding arrangement such that each group can be controlled and/or activated independently from at least another one of said groups.

This embodiment takes advantage of the above-mentioned symmetry of the aerodynamic wing in another way. Preferably, all or some of the reefing lines located on one side of central axis or said central stick are grouped together and controlled and/or conjointly activated as a group by the guiding arrangement. By combining the reefing lines on either side of the kite stick, it is possible to support the steering of the aerodynamic wing by addressing the two groups separately e.g. at different times and/or with different forces or displacements applied to the groups of reefing lines. Within a group, all reefing lines forming this group can only be addressed conjointly, i.e. all reefing lines within one group are controlled and/or activated at the same time and by the same force or displacement. Again, the guiding arrangement may be realized as described above.

In the case when more than one reefing lines are activated conjointly, these reefing lines may be merged to a smaller number of lines, e.g. one line, in particular, to facilitate the conjoint handling of more than one reefing line.

The combination of reefing lines in pairs or groups provides a somewhat lower flexibility regarding the possibility to address single reefing lines compared to an individual activation of each single reefing line, but it offers a more efficient activation mechanism, since for a given number of reefing lines less activation means are required and the guiding means may be constructed in a simpler manner. In the case the activation mechanism is located at the aerodynamic wing for example, it might be advantageous to save weight and thus choose an embodiment with less activation means.

According to a further preferred embodiment, at least one pair of said pairs or at least one group of said groups of reefing lines is controlled and/or activated by a common reel, respectively. Providing a reel is an effective mechanism to control and/or activate the reefing lines. The current embodiment arranges for one reel for each unit to be activated and/or controlled. In the case where pairs of two reefing lines are composed, a single reel serves for the control and/or activation of one pair of two reefing lines, resulting in the same number of pairs and reels. The case where groups of more than two reefing lines are composed, all reefing lines of one group are associated with one single reel, resulting in the same number of groups and reels, each reel being adopted to accommodate the according number of reefing lines of one group.

Further, it is preferred that a coupling unit at the base platform is adapted to receive at least one pair of said pairs or one group of said groups of reefing lines, individually, wherein the coupling unit is adapted to receive said reefing lines composing one pair or one group of reefing lines conjointly.

The coupling needs to comprise a number of receiving means, e.g. receiving slots, that are equal to the number of pairs or groups of reefing lines. Two or more reefing lines forming a pair or a group may be merged into one line before reaching the coupling unit.

Further, it is preferred that said at least one reel is mounted onto a shaft. Particularly all necessary reels may be mounted onto a common shaft. The shaft can be located at a kite stick or the shaft can be formed as a part of a kite stick, for example.

Further, it is preferred that the device comprises a further reel, wherein said at least two reels are connected to each other such that at least one of said reels can rotate individually. This embodiment is particularly preferred because it allows for the application of different torques to the individual reels, thus allowing the reefing lines associated with the reels to be subject to different displacements or forces.

According to a further preferred embodiment, said at least one reel is coupled to at least one drive assembly, comprising at least one first drive unit, particularly an electric motor. In order to allow for an accurate application of possibly high forces to the reefing lines it is preferred to use drive assemblies to drive the reels.

Further, it is preferred that said at least two reels are connected via a differential gear to said at least one drive assembly, in particular in that said drive assembly is the input to said differential gear and said at least two reels are the output of said differential gear. The application of a differential gear allows for two reels being driven by one drive assembly while rotating at different speeds. This way it is possible to haul in and veer out the reefing lines with the two reels at different speeds, resulting in a different amount of line length to be veered out or hauled in, while applying the same torque by the common drive assembly to the two reels via the differential gear.

This embodiment is particularly preferred because in the application of aerodynamic wind propulsion devices it is important to reduce the weight of the flying elements. In case the drive assembly is located at the aerodynamic wing for example, it is advantageous to use one drive assembly to drive more than one reel and thus save the weight for an additional drive assembly.

Further, it is preferred that said at least one drive assembly is capable of being operated in two operating modes, wherein in a first operating mode the drive assembly applies a low torque with high speed and in a second operating mode the drive assembly applies a high torque with low speed, in particular in that said at least one drive assembly comprises said first and a second drive unit, said first drive unit being capable of being operated in the first mode and said second drive unit being capable of being operated in the second mode.

This way it is possible to adjust the torque and speed applied during veering out and hauling in the reefing lines to the current situation. For example, if a long section of a reefing line has to be hauled in or veered out, while the opposing forces are low, it is desired to use an operating mode applying only a low torque and moving the reefing line at a high speed. Whereas in a situation, where forces opposing a hauling in are very high, it is preferred to use an operating mode applying a high torque at low speed.

In order to be able to apply different operating modes as described above, either one single drive assembly may be driven in two different operating modes, that can be chosen from or switched inbetween, or two separate drive units may be provided, one for the first mode and one for the second mode.

This embodiment can be further improved in that at least one coupling for selectively coupling one of said two drive units to said at least one reel.

If two drive units are used to realize the different operating modes, it has to be ensured, that the at least one reel is coupled to the drive unit corresponding to the specific operating mode. If there are two drive units associated with one reel, a coupling may selectively couple either the first or the second drive unit to the reel according to the required operating mode.

The invention can be further improved in that a guiding line connected to the aerodynamic wing and the base platform is provided, wherein said at least one reel is coupled to said guiding line such that said at least one reel is activated by hauling in and/or veering out said guiding line.

This embodiment is particularly preferred because it allows for a further reduction of the weight of the flying elements. In case a guiding line is connected to the aerodynamic wing and the base platform, this guiding line can be used to activate the reefing lines via the reels. The guiding line may be provided in addition to or replace the drive assembly as described above. This embodiment is also particularly preferred because typically the guiding line is hauled in or veered out especially during staring and landing manoeuvres, thus during such flight situations, where the reefing lines typically have to be activated.

The preferred embodiment may be further improved in that said guiding line is guided via at least one guiding line reel that is connected to said at least one reel.

Constructively, this embodiment can be realized by mounting a reel associated with the guiding line onto the same shaft the reefing line reels are mounted on. This configuration allows for the guiding line reel to induce a rotation to the reefing line reels via the shaft. The transmission ratio, the rotation orientation of the different reels and other relevant parameters can be defined in the construction according to the requirements of the application.

The invention can be further improved in that said at least one reel is located at the aerodynamic wing, particularly at a central stick, serving as a stiffening element, located at the aerodynamic wing.

In this embodiment, the reels and preferably also the shaft, onto which the reels are mounted, are located at the aerodynamic wing or the kite stick, i.e. the activation mechanism of the reefing lines is part of the flying aerodynamic wing. Particularly, the kite stick may serve as the shaft, onto which the reels are mounted. This embodiment has the advantage, that external handling of reefing lines, reels or other relevant parts of the activation mechanism outside of the aerodynamic wing may be omitted, reduced or facilitated.

According to an alternative solution, in an aerodynamic wind propulsion device comprising a pole, particularly a mast with a masthead, being connected to the base platform, the pole serving as a docking point for the aerodynamic wing during starting and landing, said at least one reel is located outside the aerodynamic wing, particularly at said pole.

In this embodiment, the reels, and preferably also the shaft, onto which the reels are mounted, are preferably located at the masthead, i.e. do not form a part of the flying aerodynamic wing. This embodiment has the advantage, that the number and weight of the flying parts of the propulsion device are reduced and thus the efficiency of the aerodynamic wing may be improved while the advantages of providing the activation mechanism are maintained.

This embodiment can be further improved in that said coupling unit is arranged at said pole.

The mast can facilitate starting and landing manoeuvres in that the tractive cable may be coupled to the masthead. In this case it is preferred that said coupling unit described above is also arranged at that masthead. Thus, the masthead can serve as a central docking point for the aerodynamic wing and accommodate the means coupling the aerodynamic wing to the base platform.

According to another aspect of the invention, the aerodynamic wind propulsion device as mentioned above or described in the introductory portion of this description comprises an aerodynamic wing being formed as a hollow body and having at least one opening in the aerodynamic wing, may be further improved by an evacuation arrangement, particularly an evacuation line, for guiding said at least one opening, wherein said evacuation arrangement is adapted to bring said at least one opening from a first position to a second position and back, wherein said at least one opening faces a higher air-pressure outside the aerodynamic wing in said first position than in said second position.

The aerodynamic wing typically comprises one or more openings in order to allow an air stream to enter the interior of the aerodynamic wing and inflate the aerodynamic profile. In some situations, particularly during landing manoeuvres, it is desirable to prevent further air from entering the aerodynamic wing and/or to deflate the aerodynamic wing. In order to do this, it is preferred to provide for an area of low pressure in front of the at least one opening. If the air pressure in front of the at least one opening on the outside of the aerodynamic wing is lower than the pressure inside the aerodynamic wing air will flow from the inside of the aerodynamic wing to the outside.

In this embodiment, the at least one opening itself is moved in order to deflate the wing. This may be realized by providing flexibility to the wing and turning the part of the aerodynamic wing comprising the at least one opening into a direction, where the air flow conditions create an area of lower pressure on the outside of the aerodynamic wing.

According to a further aspect of the invention, the aerodynamic wind propulsion device is characterized in that an aerodynamic element located on the aerodynamic wing and an evacuation arrangement, particularly an evacuation line, for guiding said aerodynamic element is provided, wherein said evacuation arrangement is adapted to bring said aerodynamic element from a first position to a second position and back, wherein said aerodynamic element causes a lower air-pressure outside the aerodynamic wing in front of the at least one opening in said second position then in said first position.

In this solution, a similar result as in the embodiment discussed before is achieved in a different way. In the present embodiment this effect is realized by providing an aerodynamic element located on the aerodynamic wing that can be moved to a position where it causes the air pressure in front of the at least one opening to drop. The aerodynamic element can be a cowl or the like, preferably made out of a similar or the same material as the aerodynamic wing. This aerodynamic element can be moved back to its original position, thus being adapted to reversibly induce an area of low pressure in front of the at least one opening.

The evacuation arrangement may be secured to said at least one opening at one point and/or to said aerodynamic element at one point, respectively.

The evacuation arrangement may preferably be secured to the aerodynamic wing, particularly to a central stick, serving as a stiffening element, located at the aerodynamic wing and/or to a guiding line connected to the aerodynamic wing and the base platform or said guiding line mentioned above, respectively.

Further, it is preferred that said evacuation arrangement is adapted to be controlled and/or activated by said central stick and/or said guiding line, respectively, in that the evacuation line is partly wound around a part of the central stick and controlled and/or activated by a rotation of said part of the central stick and/or in that the evacuation arrangement is coupled to the guiding line such that the evacuation arrangement is controlled and/or activated by hauling in and/or veering out the guiding line.

This embodiment is particularly preferred because it allows to activate the evacuation arrangement via constituent parts of the aerodynamic wind propulsion device, thus using these existing elements to execute further functions, i.e. to activate the evacuation arrangement. It may be ensured though, that the activation mechanism of the evacuation arrangement can be detached from the kite stick and/or guiding line in order to allow for separate activation of the kite stick and/or the guiding line without activating the evacuation arrangement. The evacuation arrangement may preferably be guided via a pulley, particularly a pulley located at the rear end of the aerodynamic wing or may be connected to a turning point at the aerodynamic wing, particularly the upper part of the aerodynamic wing.

In a further aspect, the invention may be embodied in a watercraft, comprising an aerodynamic wind propulsion device as described above. In this respect, reference is made to the international applications mentioned in the introduction of this description describing such systems for towing watercraft.

Further, the invention may be embodied in the use of an aerodynamic wind propulsion device as described above to drive a watercraft.

According to a further aspect of the invention, a method for controlling an aerodynamic wind propulsion device, as described in the introductory part of this description, is provided, that is characterized by the step of controlling and/or activating at least two reefing lines, particularly hauling in and veering out, independently from each other.

The method according to the invention can be improved as described in claims 27-38. As to the advantages, preferred embodiments and details of these further preferred embodiments, reference is made to the corresponding embodiments described above.

According to a further aspect of the invention, a method for controlling an aerodynamic wind propulsion device, as mentioned above or described in the introductory portion of this description, is provided, comprising the step of providing at least one opening in the mantle of an aerodynamic wing formed as a hollow body, that is characterized by the step of moving said at least one opening from a first position to a second position, wherein said at least one opening faces a higher air-pressure outside the aerodynamic wing in said first position than in said second position and/or that is characterized by the step of moving an aerodynamic element from a first position to a second position, wherein said aerodynamic element induces a lower air-pressure outside the aerodynamic wing in front of the at least one opening in said second position than in said first position. The method according to the invention can be improved as described in claim 41.

As to the advantages, preferred embodiments and details of these further aspects of the invention and their improvements, reference is made to the corresponding aspects of the embodiments described above.

Further, it is preferred, that the method according to the invention is improved by the step: moving said at least one opening and/or said aerodynamic element from said first position to said second position during a reefing procedure, wherein the beginning of said reefing procedure depends on forces in said reefing lines and/or on forces in said guiding line, respectively, and/or on a position of the aerodynamic wing above the base platform.

Starting and landing manoeuvres are complex processes, where various influencing parameters and conditions have to be controlled and measures have to be taken accordingly. The activation of the at least one opening and/or the aerodynamic element is one of these measures that have to be induced in adjustment and coordination with other measures and according to surrounding conditions. Especially the reefing forces or applied torques, respectively, the generated uplift force and the height of the aerodynamic wing above the base platform are parameters, that are of special importance for the moment of activation of the movement of the at least one opening and/or the aerodynamic element.

Preferred embodiments of the invention shall now be described with reference to the attached drawings, in which

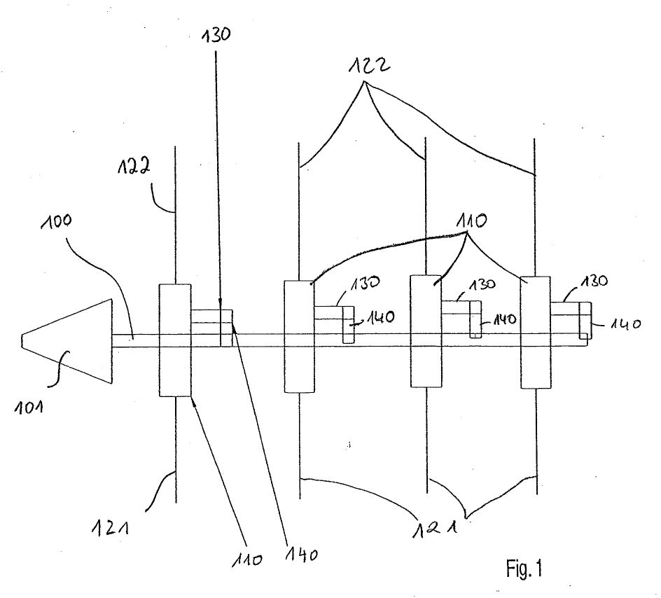

FIG. 1: shows a schematic plan view of a first embodiment of a part of a guiding arrangement according to the invention,

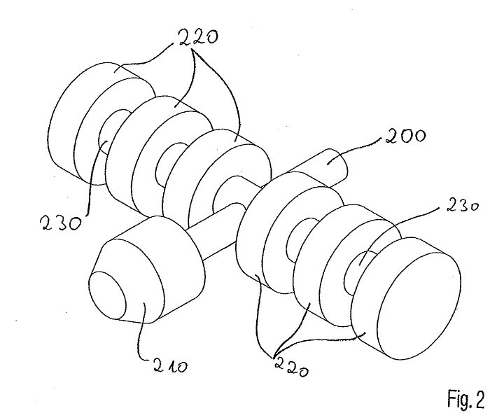

FIG. 2: shows a perspective view of a second embodiment of a guiding arrangement according to the invention,

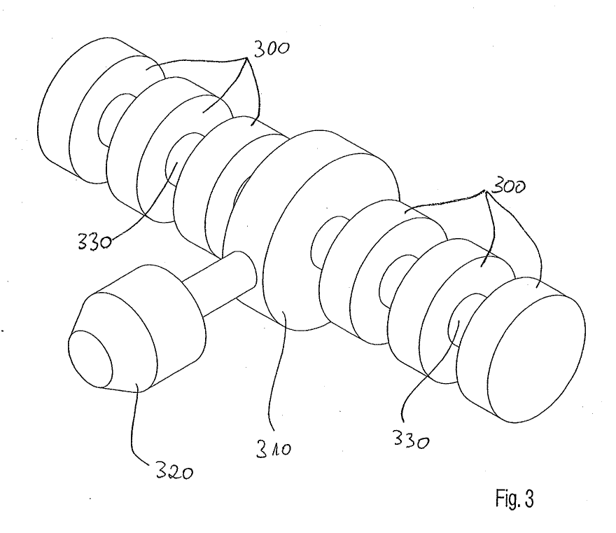

FIG. 3: shows a perspective view of a third embodiment of a guiding arrangement according to the invention,

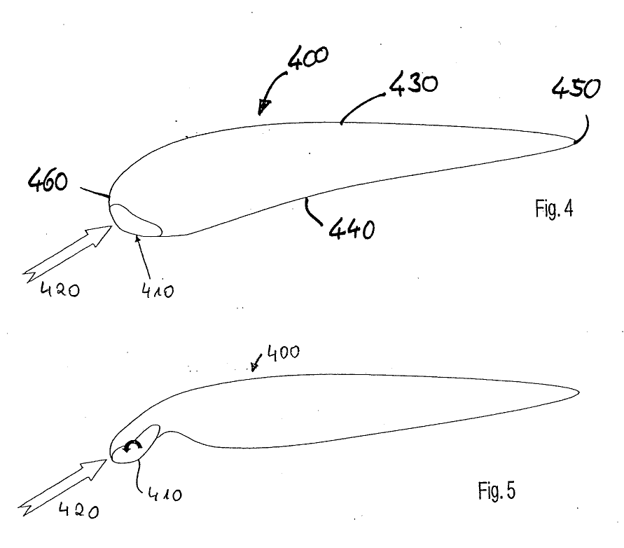

FIG. 4: shows a schematic sectional view of a an aerodynamic wing according to the invention in an inflating configuration,

FIG. 5: shows a schematic sectional view of the aerodynamic wing of FIG. 4 in a deflating configuration,

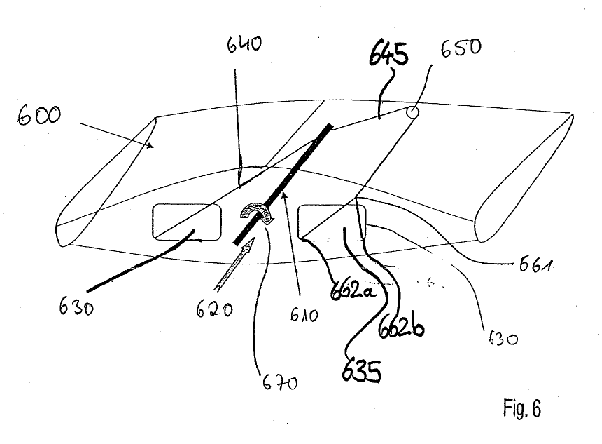

FIG. 6: shows a perspective view of a first alternative embodiment of an evacuation arrangement according to the invention, and

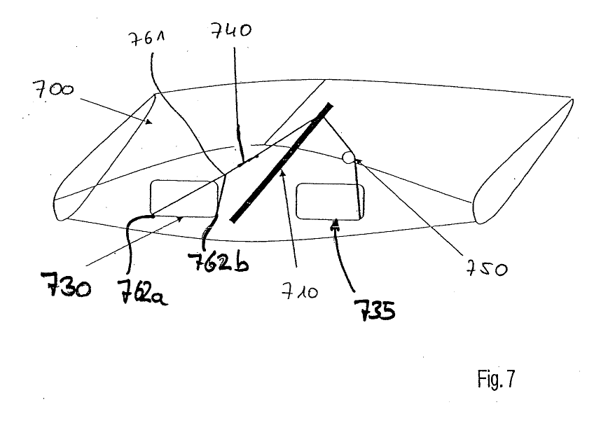

FIG. 7: shows a perspective view of a second alternative of an evacuation arrangement according to the invention.

FIG. 1 shows a plan view of a kite stick 100 of an aerodynamic wing of an aerodynamic wind propulsion device according to the invention. The kite stick comprises a kite head 101, which is particularly used for coupling the kite to a masthead (not shown) on a nautic vessel (not shown) during starting and landing.

The kite stick 100 serves as a shaft onto which several reels 110 are mounted. Each of the reels 110 can be rotated individually on the shaft 100. This is particularly preferred because it allows for the application of different torques and/or angles of rotation to the individual reels 110, thus allowing the reefing lines 121, 122 associated with the different reels 110 to be subject to different forces and/or displacements. This means that the tensile forces and/or the displacements applied to the pairs of reefing lines 121, 122 are controlled separately, particularly by not hauling in or veering out all pairs of reefing lines 121, 122 at the same time and by the same amount, but rather controlling time and amount of activation of different pairs of reefing lines 121, 122 individually. These requirements can depend intrinsically on the location of a reefing line at the aerodynamic wing or the position, in particular the altitude, of the aerodynamic wing in relation to the base platform, and extrinsically on wind conditions, sea conditions, vessel speed or other conditions.

Each reel 110 accommodates two reefing lines 121, 122 opposite to each other, one reefing line on either side of the kite stick 100, which is secured to the aerodynamic wing (not shown). The two reefing lines 121, 122 located opposite to each other on either side of the central stick, are controlled and/or activated by a common reel 110.

Each pair of reefing lines is controlled and/or activated individually, wherein each two reefing lines 121, 122 composing one pair of reefing lines are controlled and/or activated conjointly. This takes into account, that the aerodynamic wing and its aerodynamic profile usually are symmetric to a central axis, in particular to the axis of the kite stick. Thus it can be desirable, to conjointly address reefing lines, that are located at two points of the aerodynamic wing that are symmetric to the kite axis, in order to symmetrically apply forces to the aerodynamic wing and thus symmetrically change the aerodynamic profile. In this case the activation of a first reefing line within a pair, e.g. reefing line 121, is defined by the activation of the corresponding second reefing line within that pair located opposite to the first reefing line across the kite stick, i.e. reefing line 122. In contrast, the activation of pairs of reefing lines along the kite stick axis can be adjusted independently from the activation of other pairs.

Each reel 110 is associated with a unit 130 comprising a motor and a gear. The motor drives the reel 110 via the gear in order to haul in or veer out the reefing lines 121, 122.

The motors are capable to operate in two operating modes, wherein a first operating mode applies a low torque with high speed and a second operating mode applies a high torque with low speed. This way it is possible to adapt the torque and speed used during veering out and hauling in the reefing lines 121, 122 to the current situation and to reduce weight of the unit 130.

The unit 130 is supported by a torque bearer 140 which connects the unit 130 with the kite stick 100.

FIG. 2 shows a perspective view of the kite stick 200 having a kite head 210, and comprising a shaft 230. Several reels 220 each for accommodating one single reefing line (not shown) are mounted onto the shaft 230. The reels 220 are driven by a motor (not shown) which is located within the kite head 210.

In the configuration of FIG. 2 each reefing line (not shown) is controlled and/or activated by one reel 220. Providing a reel is an effective mechanism to control and/or activate each of the reefing lines individually.

FIG. 3 shows a perspective view of a guiding arrangement, wherein reefing lines (not shown) that are accommodated by reels 300 mounted onto a shaft 330, are coupled to a guiding line reel 310 mounted onto the same shaft 330. The reel 310 accommodates a guiding line (not shown).

Applying a tensile force to the guiding line wound around the guiding line reel will effect rotation of the guiding line reel. Such rotation of the guiding line reel 310 induces a rotation of the reefing line reels 300. The reefing lines may effect an opposing torque via the reefing line reels onto the shaft if the aerodynamic wing is exposed to a flow of air inflating the wing. Thus the reels 300 may be rotated by veering out or hauling in the guiding line connected to the aerodynamic wing and the base platform. This is also particularly preferred because typically the guiding line is hauled in or veered out especially during staring and landing manoeuvres, thus during those flight conditions, wherein the reefing lines have to be activated.

In the embodiment of FIG. 3 a reel 310 associated with a guiding line (not shown) is mounted onto the same shaft 330 whereupon the reefing line reels 300 are coupled to. This configuration allows for the guiding line reel 310 to induce a rotation to the reefing line reels 300 via the shaft 330. The transmission between the guiding line reel 310 and the reels 300 can be decoupled to allow application of tensile forces to the guiding line without effecting any hauling in or veering out of the reefing lines. Preferably, rotation of the shaft 330 can be blocked by a locking device.

FIG. 4 shows a sectional view of a an aerodynamic wing 400 in an inflating configuration. The aerodynamic wing is shaped in a typical profile of an aerofoil and is defined by an upper flexible textile 430 and a lower flexible textile 440. The textiles 430, 440 are connected at a rear end 450 to form a sharp tip. At a front end position, the textiles 430, 440 form a rounded front face 460. The air stream direction is indicated by arrow 420. In the lower half of the front face 460 an opening 410 is provided. FIG. 4 shows the situation, where there is an area of high pressure in front of the opening 410 and the air stream through the opening 410 is directed from the outside of the aerodynamic wing 400 to the inside of the aerodynamic wing 400, thus inflating the aerodynamic wing 400 with air.

FIG. 5 shows the aerodynamic wing of FIG. 4 during the situation, where the opening 410 has been turned such that it faces an area with lower air pressure on the outside of the aerodynamic wing 400 than on the inside of the aerodynamic wing 400. Thus, the air stream through the opening 410 is directed from the high pressure inside of the aerodynamic wing 400 towards the low pressure area in front of the opening 410 on the outer side of the aerodynamic wing 400. Thus, the air stream is deflating the aerodynamic wing 400 in the situation shown in FIG. 5.

FIG. 6 shows a first alternative embodiment of an evacuation arrangement according to the invention, comprising an aerodynamic wing 600 formed as a hollow body and a kite stick 610 arranged inside the wing 600. The air flow direction is indicated with arrow 620. The aerodynamic wing 600 according to the invention comprises a portside opening 630 in the front face of the wing. An evacuation line 640 is coupled to a point of the edge of the portside opening 630 at its one end and wound around the kite stick 610 at its other end.

Further, a starboard opening 635 is provided in the front face of the wing, opening 635 being arranged symmetrical to opening 630 with respect to the kite stick 610.

A second evacuation line 645 is wound around the kite stick 610 and is guided via a pulley 650 at the rear end of the aerodynamic wing 600. The pulley 650 allows for a more accurate addressing of the evacuation line 640 and thus provides for a better control of the movement of the openings 630.

At point 661 the evacuation line 640 fans out in order to be connected to the edge of the opening 630 at two points 662a,b. By connecting the edge of the opening 630 at more than one point to the evacuation line 640, the movement of the opening 630 can be controlled more accurately.

By turning the kite stick 610 into the direction indicated with arrow 670, the evacuation lines 640, 645 is activated and exerts forces to the openings 630 such that the openings 630, 635 are moved to a position wherein a lower pressure on the outside of the aerodynamic wing 600 is present before the openings 630 then in the configuration shown in FIG. 6.

FIG. 7 shows a second alternative embodiment of an evacuation arrangement according to the invention comprising an aerodynamic wing 700 with a kite stick 710 and two openings 730, 735 as in FIG. 6. As in FIG. 6 an evacuation line 740 fans out at point 761 in order to be connected to the edge of the opening 730 at two points 762a,b, with similar advantages as described with reference to FIG. 6. In the embodiment shown in FIG. 7, a pulley 750 guiding a further evacuation line 745 is located at the rear section of the aerodynamic wing 700, allowing for a more accurate addressing of the evacuation line 745 and thus provides for a better control of the movement of the opening 735.

1. Aerodynamic wind propulsion device, particularly for watercraft, comprising
an aerodynamic wing (400, 600, 700) being connected to a steering unit located below the aerodynamic wing (400, 600, 700) and coupled to the aerodynamic wing via a plurality of lines, particularly steering lines and/or fixing lines,
a tractive cable, wherein a first end of the tractive cable is connected to the steering unit and a second end of the tractive cable is connected to a base platform,
the aerodynamic wing (400, 600, 700) having an aerodynamic profile which generates a lifting force in the direction of the traction cable when the air stream direction is about perpendicular to the tractive cable,
a plurality of reefing lines (121, 122) located across the aerodynamic wing (400, 600, 700) for increasing and decreasing the lifting force by changing the shape and/or dimension of the aerodynamic wing,
characterized by a guiding arrangement for guiding the reefing lines (121, 122), wherein at least two of the reefing lines (121, 122) are guided by the guiding arrangement such that said at least two reefing lines (121, 122) can be controlled and/or activated, particularly hauled in and veered out, independently from each other, in particular during starting and landing manoeuvres.

2. Aerodynamic wind propulsion device according to claim 1,
characterized in that
each reefing line (121, 122) is guided by the guiding arrangement such that each said reefing line (121, 122) can be controlled and/or activated independently from at least another one of said reefing lines (121, 122).

3. Aerodynamic wind propulsion device according to claim 2,
characterized in that each reefing line (121, 122) is controlled and/or activated by one reel (110, 220, 300).

4. Aerodynamic wind propulsion device according to claim 3,
characterized in that a coupling unit at the base platform is adapted to receive each reefing line (121, 122) individually.

5. Aerodynamic wind propulsion device according to claim 1,
characterized in that
at least two pairs of reefing lines are provided, each said pair comprising two reefing lines (121, 122) located opposite to each other on either side of a central longitudinal axis of said wing, in particular on either side of a central stick (100, 200, 610, 710), serving as a stiffening element, located at the aerodynamic wing (400, 600, 700),
wherein said two reefing lines composing one pair of reefing lines (121, 122) are guided by said guiding arrangement such that said two reefing lines (121, 122) are controlled and/or activated conjointly, and
wherein at least two pairs of said pairs of reefing lines (121, 122) are guided by the guiding arrangement such that each pair can be controlled and/or activated independently from at least another one of said pairs.

6. Aerodynamic wind propulsion device according to claim 1,
characterized in that
at least two groups of reefing lines (121, 122) are provided, each said group comprising more than two reefing lines (121, 122), particularly reefing lines (121, 122) located on one side of a central longitudinal axis of said wing, in particular on one side of a central stick (100, 200, 610, 710), serving as a stiffening element, located at the aerodynamic wing (400, 600, 700),
wherein said more than two reefing lines (121, 122) composing one group of reefing lines (121, 122) are guided by said guiding arrangement such that said more than two reefing lines (121, 122) are controlled and/or activated conjointly, and
wherein at least two groups of said groups of reefing lines (121, 122) are guided by the guiding arrangement such that each group can be controlled and/or activated independently from at least another one of said groups.

7. Aerodynamic wind propulsion device according to claim 5,
characterized in that at least one pair of said pairs or at least one group of said groups of reefing lines (121, 122) is controlled and/or activated by a common reel (110, 220, 300), respectively.

8. Aerodynamic wind propulsion device according to claim 7,
characterized in that a coupling unit at the base platform is adapted to receive at least one pair of said pairs or one group of said groups of reefing lines (121, 122), respectively, individually, wherein the coupling unit is adapted to receive said reefing lines (121, 122) composing one pair or one group of reefing lines (121, 122), respectively, conjointly.

9. Aerodynamic wind propulsion device according to claim 3,
characterized in that said at least one reel (110, 220, 300) is mounted onto a shaft (100, 200).

10. Aerodynamic wind propulsion device according to claim 3,
characterized by a further reel (110, 220, 300), wherein said at least two reels (110, 220, 300) are connected to each other such that at least one of said reels (110, 220, 300) can rotate individually.

11. Aerodynamic wind propulsion device according to claim 3,
characterized in that said at least one reel (110, 220, 300) is coupled to at least one drive assembly (130), comprising at least one first drive unit, particularly an electric motor.

12. Aerodynamic wind propulsion device according to claim 11,
characterized in that said at least two reels (110, 220, 300) are connected via a differential gear to said at least one drive assembly, in particular in that said drive assembly (130) is the input to said differential gear and said at least two reels are the output of said differential gear.

13. Aerodynamic wind propulsion device according to claim 11,
characterized in that said at least one drive assembly (130) is capable of being operated in two operating modes, wherein in a first operating mode the drive assembly applies a low torque with high speed and in a second operating mode the drive assembly applies a high torque with low speed, in particular in that said at least one drive assembly (130) comprises said first and a second drive unit, said first drive unit being capable of being operated in the first mode and said second drive unit being capable of being operated in the second mode.

14. Aerodynamic wind propulsion device according to claim 13,
comprising at least one coupling for selectively coupling one of said two drive units to said at least one reel (110, 220, 300).

15. Aerodynamic wind propulsion device according to claim 3,
characterized by a guiding line connected to the aerodynamic wing and the base platform, wherein said at least one reel (110, 220, 300) is coupled to said guiding line such that said at least one reel (110, 220, 300) is activated by hauling in and/or veering out said guiding line.

16. Aerodynamic wind propulsion device according to claim 15,
characterized in that said guiding line is guided via at least one guiding line reel that is connected to said at least one reel.

17. Aerodynamic wind propulsion device according to claim 3,
characterized in that said at least one reel is (110, 220, 300) located at the aerodynamic wing (400, 600, 700), particularly at a central stick (100, 200, 610, 710), serving as a stiffening element, located at the aerodynamic wing (400, 600, 700).

18. Aerodynamic wind propulsion device according to claim 3,
comprising a pole, particularly a mast with a masthead, being connected to the base platform, the pole serving as a docking point for the aerodynamic wing (400, 600, 700) during starting and landing,
characterized in that said at least one reel (110, 220, 300) is located outside the aerodynamic wing (400, 600, 700), particularly at said pole.

19. Aerodynamic wind propulsion device according to claim 18,
characterized in that a coupling unit at the base platform is arranged at said pole.

20. Aerodynamic wind propulsion device according to claim 1,
wherein the aerodynamic wing is a hollow body which is inflatable,
comprising at least one opening (410, 630, 635, 730, 735) in the aerodynamic wing (400, 600, 700),
characterized by an evacuation arrangement, particularly an evacuation line (640, 645, 740, 745), for guiding said at least one opening (410, 630, 635, 730, 735), wherein said evacuation arrangement is adapted to bring said at least one opening (410, 630, 635, 730, 735) from a first position to a second position and back, wherein said at least one opening (410, 630, 635, 730, 735) faces a higher air-pressure outside the aerodynamic wing (400, 600, 700) in said first position than in said second position.

21. Aerodynamic wind propulsion device according to claim 20,
characterized by an aerodynamic element located on the aerodynamic wing (400, 600, 700) and an evacuation arrangement, particularly an evacuation line (640, 645, 740, 745), for guiding said aerodynamic element, wherein said evacuation arrangement is adapted to bring said aerodynamic element from a first position to a second position and back, wherein said aerodynamic element causes a lower air-pressure outside the aerodynamic wing (400, 600, 700) in front of the at least one opening (410, 630, 635, 730, 735) in said second position than in said first position.

22. Aerodynamic wind propulsion device according to claim 20,
characterized in that said evacuation arrangement is secured to the aerodynamic wing (400, 600, 700), particularly to a central stick (100, 200, 610, 710), serving as a stiffening element, located at the aerodynamic wing (400, 600, 700) and/or to a guiding line connected to the aerodynamic wing (400, 600, 700) and the base platform or said guiding line of claim 15, respectively.

23. Aerodynamic wind propulsion device according to claim 22,
characterized in that said evacuation arrangement is adapted to be controlled and/or activated by said central stick (100, 200, 610, 710) and/or said guiding line, respectively, in that the evacuation arrangement is partly wound around the central stick (100, 200, 610, 710) and controlled and/or activated by a rotation of at least a part of the central stick (100, 200, 610, 710) and/or in that the evacuation arrangement is secured to the guiding line such that the evacuation arrangement is controlled and/or activated by hauling in and/or veering out the guiding line.

24. A watercraft comprising an aerodynamic wind propulsion device according to claim 1.

25. Use of an aerodynamic wind propulsion device according to claim 1 to drive a watercraft.

26. Method for controlling an aerodynamic wind propulsion device, particularly for watercraft, comprising the steps
connecting an aerodynamic wing (400, 600, 700) to a steering unit located below the aerodynamic wing and coupled to the aerodynamic wing (400, 600, 700) via a plurality of lines, particularly steering lines and/or fixing lines,
connecting a first end of a tractive cable to the steering unit and a second end of the tractive cable to a base platform,
locating a plurality of reefing lines (121, 122) across the aerodynamic wing (400, 600, 700) for increasing and decreasing the lifting force by changing the shape and/or dimension of the aerodynamic wing (400, 600, 700),
characterized by the step
controlling and/or activating at least two of the reefing lines (121, 122), particularly hauling in and veering out, independently from each other.

27. Method according to claim 26,
characterized by the step
controlling and/or activating each reefing line (121, 122) independently from at least another one of said reefing lines (121, 122).

28. Method according to claim 27,
characterized by the step
controlling and/or activating each reefing line by one reel (110, 220, 300).

29. Method according to claim 28,
characterized by the step
transferring each reefing line (121, 122) individually to a coupling unit at the base platform.

30. Method according to claim 26,
characterized by the steps
providing at least two pairs of reefing lines, each said pair comprising two reefing lines (121, 122) located opposite to each other on either side of a central longitudinal axis of said wing, in particular on either side of a central stick (100, 200, 610, 710), serving as a stiffening element, located at the aerodynamic wing (400, 600, 700),
controlling and/or activating said two reefing lines (121, 122) composing one pair of reefing lines (121, 122) conjointly, and
controlling and/or activating at least two pairs of said pairs of reefing lines (121, 122) independently from at least another one of said pairs.

31. Method according to claim 26,
characterized by the steps
providing at least two groups of reefing lines (121, 122), each said group comprising more than two reefing lines (121, 122), particularly reefing lines (121, 122) located on one side of a central longitudinal axis of said wing, in particular on one side of a central stick (100, 200, 610, 710), serving as a stiffening element, located at the aerodynamic wing (400, 600, 700),
controlling and/or activating said more than two reefing lines (121, 122) composing one group of reefing lines conjointly, and
controlling and/or activating at least two groups of said groups of reefing lines (121, 122) independently from at least another one of said groups.

32. Method according to claim 30,
characterized by the steps
controlling and/or activating at least one pair of said pairs or one group of said groups of reefing lines (121, 122) by a common reel (110, 220, 300), respectively.

33. Method according to claim 32,
characterized by the step
transferring at least one pair of said pairs at least one group of said groups of reefing lines (121, 122), respectively, individually to a coupling unit at the base platform, wherein said coupling unit is adapted to receive said reefing lines (121, 122) composing one pair or one group of reefing lines (121, 122), respectively, conjointly.

34. Method according to claim 28,
characterized by the step
coupling said at least one reel (110, 220, 300) to at least one drive assembly (130), comprising at least one first drive unit, particularly an electric motor.

35. Method according to claim 34,
characterized by the step
operating said at least one drive assembly (130) in two operating modes, wherein in a first operating mode the drive assembly applies a low force with high speed and in a second operating mode drive assembly applies a high force with low speed, in particular in that said at least one drive assembly (130) comprises said first and a second drive unit, said first drive unit being capable of being operated in the first mode and said second drive unit being capable of being operated in the second mode.

36. Method according to claim 28,
characterized by the steps
coupling said at least one reel (110, 220, 300) to a guiding line connected to the aerodynamic wing (400, 600, 700) and the base platform,
activating said at least one reel (110, 220, 300) by hauling in and/or veering out said guiding line.

37. Method according to claim 28,
characterized by the step
locating said at least one reel (110, 220, 300) at the aerodynamic wing (400, 600, 700), particularly at a central stick (100, 200, 610, 710), serving as a stiffening element, located at the aerodynamic wing (400, 600, 700).

38. Method according to claim 28,
comprising the step
providing a pole, particularly a mast with a masthead, being connected to the base platform, said pole serving as a docking point for the aerodynamic wing (400, 600, 700) during starting and landing,
characterized by the step
locating said at least one reel (110, 220, 300) outside the aerodynamic wing (400, 600, 700), particularly at said pole.

39. Method according to claim 26, wherein the aerodynamic wing is a hollow body which is inflatable,
comprising the step
providing at least one opening (410, 630, 635, 730, 735) in the mantle of an aerodynamic wing (400, 600, 700) formed as a hollow body,
characterized by the step
moving said at least one opening (410, 630, 635, 730, 735) from a first position to a second position, wherein said at least one opening (410, 630, 635, 730, 735) faces a higher air-pressure outside the aerodynamic wing (400, 600, 700) in said first position than in said second position.

40. Method according to claim 39,
characterized by the step
moving an aerodynamic element from a first position to a second position, wherein said aerodynamic element induces a lower air-pressure outside the aerodynamic wing (400, 600, 700) in front of the at least one opening in said second position than in said first position.

41. Method according to claim 39,
characterized by the step
moving the opening or the element respectively by a rotation of at least a part of a central stick (100, 200, 610, 710), serving as a stiffening element, located at the aerodynamic wing (400, 600, 700) and/or by hauling in and/or veering out a guiding line connected to the aerodynamic wing (400, 600, 700) and the base platform or said guiding line of claim 36, respectively.

42. Method according to claim 39,
characterized by the step
moving said at least one opening (410, 630, 635, 730, 735) and/or said aerodynamic element from said first position to said second position during a reefing procedure, wherein the beginning of said reefing procedure depends on forces in said reefing lines and/or on forces in said guiding line, respectively, and/or on a position of the aerodynamic wing (400, 600, 700) above the base platform.
